(19) United States
(12) Patent Application Publication
(10) Pub. No.: US 2006/0072309 A1
(43) Pub. Date: Apr. 6, 2006

(54) Combination of a lantern handle and an electrical torch

(76) Inventor: Hsiao-Chung Yang, Chungho City (TW)

Correspondence Address: Troxell Law Office PLLC, Suite 1404, 5205 Leesburg Pike, Falls Church, VA, 22041, US

(21) Appl. No.: 10/958,353

(22) Filed: Oct. 6, 2004

(51) Int. Cl. F21L 4/00

(52) U.S. Cl. 362/190; 362/399

(57) ABSTRACT

A lantern handle has an open end defined to allow communication between an interior and an exterior of the handle and to allow an extension of an electrical torch into the lantern handle. The electrical torch includes a pushbutton mounted on its periphery. A securing device is pivotally connected to an outer periphery of the handle to selectively clamp the pushbutton of the electrical torch.

### BACKGROUND OF THE INVENTION

1. Field of the Invention

The present invention relates to a combination of a lantern handle and an electrical torch, and more particularly to a lantern handle having a receiving space defined to receive therein the electrical torch and a securing device mounted on an inner face defining the receiving space to secure the electrical torch.

2. Description of Related Art

A conventional lantern has a body with an illuminating element mounted inside the body and a handle pivotally connected to the body such that a user is able to hold the lantern easily. At night, when the lantern is lit in a tent, people may gather around the lantern and relax themselves via telling jokes, singing songs or the like. However, when someone has to attend other matters outside the tent, that person has to carry an electrical torch so as to light the path. At this instance, if the electrical torch has not been sited carefully, the user will have difficulty locating the electrical torch due to the darkness. Furthermore, because the electrical torch and the lantern are two separate elements, the user has to provide space big enough to store these two items, which is quite inconvenient to the user.

To overcome the shortcoming, the present invention tends to provide a combination of an electrical torch and a lantern handle to mitigate the aforementioned problems.

### SUMMARY OF THE INVENTION

The primary objective of the present invention is to provide an improved lantern handle provided with a receiving space inside the handle to partially receive therein the electrical torch and a securing device on the lantern handle to secure the electrical torch. Therefore, the user is able to easily have access to the electrical torch so long as the lantern is available.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the lantern of the present invention;

FIG. 2 is an exploded perspective view showing the structure of the lantern. handle and the electrical torch;

FIG. 3 is an exploded perspective view of a portion of the lantern handle; and

FIGS. 4 and 5 are schematic views showing how the securing device is applied to secure the electrical torch inside the lantern.

### DETAILED DESCRIPTION OF THE PREFERRED EMBODIMENT

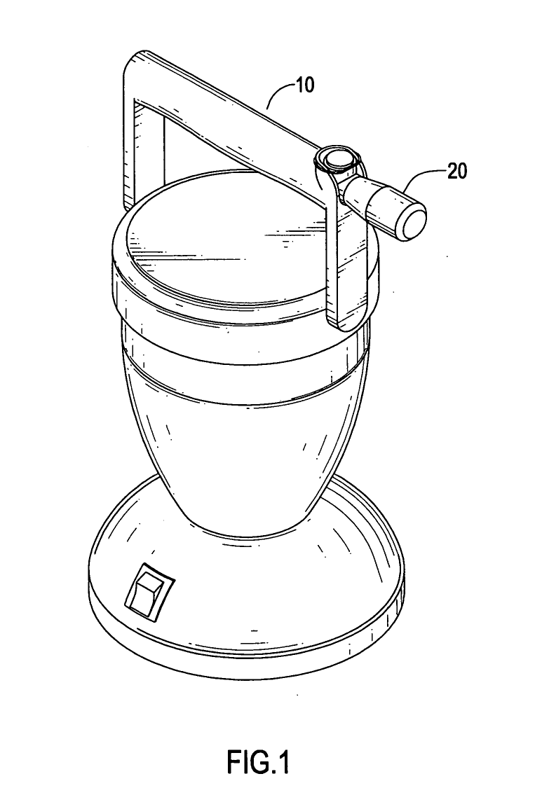

With reference to FIG. 1, the combination of a lantern handle and an electrical torch of the present invention is shown. It is appreciated that the lantern is provided with an illuminating element (not shown nor numbered) inside a lantern body (not numbered) and a control button mounted on a base of the lantern to control actuation of the lantern. Since how the lantern and the control button work are conventional in the art, detailed description thereof is omitted for brevity.

The lantern of the present invention includes a handle (10) pivotally connected to the body of the lantern and an electrical torch (20) detachably received in the handle (10).

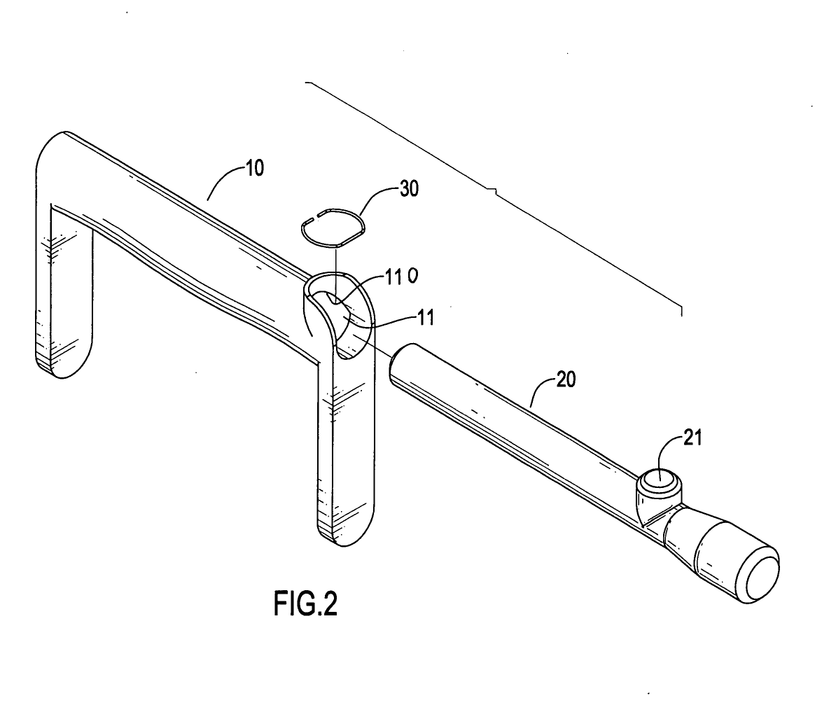

With reference to FIG. 2, it is noted that the handle (10) is hollow and has an open end (11) longitudinally defined in the handle (10) to allow communication between an interior and an exterior of the hollow handle (10) and an axial hole (110) axially defined through an outer periphery of the lantern handle (10) to communicate with the open end (11). A securing device (30) is provided outside the hollow handle (10). In this embodiment, the securing device (30) is a C-clip. The electrical torch (20) has a pushbutton (21) extending upward from an outer periphery of the electrical torch (20). The handle (10) further has a sectorial wall (12) integrally formed around a peripheral edge defining the open end (11) without blocking the open end (11).

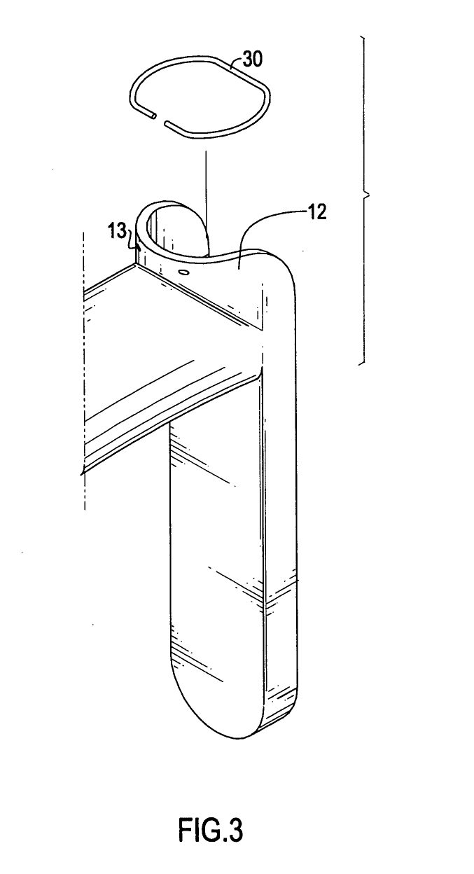

With reference to FIG. 3, it is noted that a through hole (13) is defined through an outer periphery of the sectorial wall (12) to correspond to two ends of the C-clip (30).

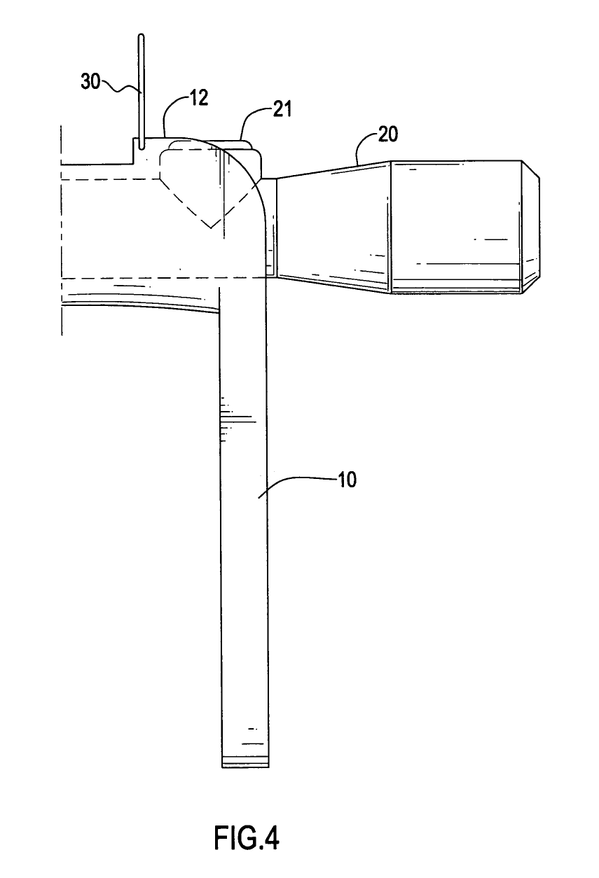

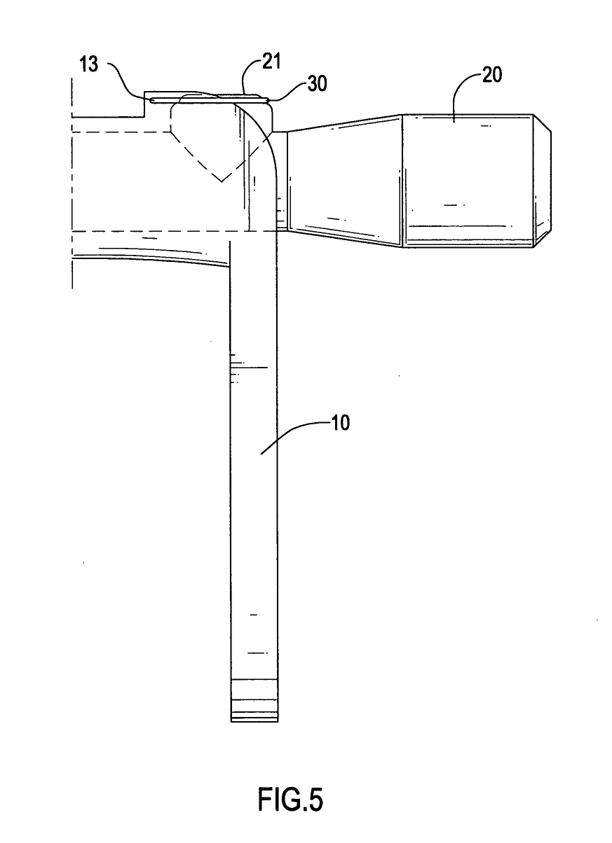

From the depiction of FIGS. 4 and 5, after the insertion of the two ends of the C-clip (30) into two open ends of the corresponding through hole (13) and the insertion of the electrical torch (20) into the hollow lantern handle (10) from the open end (11), an inner face of the sectorial wall (12) abuts the pushbutton (21) of the electrical torch (20) while the pushbutton (21) is received in the axial hole (110). Then the user is able to pivot the C-clip (30) to allow the C-clip (30) to circle an outer periphery of the pushbutton (21) such that the electrical torch (20) is securely retained by the C-clip (30). That is, after the electrical torch (20) is secured inside the lantern handle (10) by the C-clip (30), the user is able to carry the lantern to places the user likes without worrying that the electrical torch (20) will become loose in and fall the lantern.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A combination of a lantern handle and an electrical torch, wherein
the electrical torch comprises a pushbutton mounted on an outer periphery of the electrical torch;
wherein the lantern handle comprises an open end defined to allow communication between an interior and an exterior of the handle and to allow an extension of the electrical torch into the lantern handle and a securing device pivotally connected to an outer periphery of the handle to selectively clamp the pushbutton of the electrical torch.

2. The combination as claimed in claim 1, wherein the lantern handle further has an axial hole axially defined in the outer periphery of the lantern handle to communicate with the open end and to receive therein the pushbutton of the electrical torch, and a sectorial wall formed around an outer periphery defining the open end to abut the pushbutton of the electrical torch.

3. The combination as claimed in claim 2, wherein the securing device is a C-clip.

4. The combination as claimed in claim 3, wherein a through hole is defined through an outer periphery of the sectorial wall to correspond to two ends of the C-clip so that the C-clip is able to pivot relative to the lantern handle and to selectively clamp the pushbutton of the electrical torch.
